(19) United States
(12) Patent Application Publication
(10) Pub. No.: US 2011/0174230 A1
(43) Pub. Date: Jul. 21, 2011

(54) FERTILIZED EGGS COLLECTION APPARATUS

(75) Inventors: Yutaka Tamaru, Tsu-shi (JP); Hideo Miyake, Mie (JP); Shinichi Akiyama, Aichi (JP); Masaru Obata, Mie (JP); Tsuneaki Ueta, Mie (JP)

(73) Assignee: HASHIMOTO ELECTRONIC INDUSTRY CO., LTD., Matsusaka-shi, Mie (JP)

(21) Appl. No.: 13/121,627

(22) PCT Filed: Dec. 3, 2009
(86) PCT No.: PCT/JP2009/006606

§ 371 Date: Mar. 29, 2011

(30) Foreign Application Priority Data
Dec. 8, 2008 (JP) 2008-312335
Dec. 8, 2008 (JP) 2008-312342

(51) Int. Cl. A01K 61/00

(52) U.S. Cl. 119/218

(57) ABSTRACT

A fertilized eggs collection apparatus for injecting genes, which is superior in safety and productivity. It is realized by simple structure. Fertilized eggs are collected from drainage with the fertilized egg in a water tank. The collection is synchronized for starting of illumination to the water tank. A probability that that feces included in the water is mixed in the collected fertilized eggs can hereby be reduced. Water including the fertilized eggs is accumulated on a fertilized-egg-holding-plate. The fertilized-egg-holding-plate has each concave portion holding one fertilized egg each. Water in the concave portions is drained from a through-hole. The fertilized-egg-holding-plate is accommodated in a case having a bottom plate portion. The case keeps water for the fertilized eggs. A shutter plate capable of sliding is disposed on the fertilized-egg-holding-plate. The shutter plate prevents that the fertilized eggs jump out from the concave portions of the fertilized-egg-holding-plate.

### BACKGROUND OF INVENTION

1. Field of the Invention

The present invention relates to an apparatus collecting fertilized eggs, in particular to the apparatus collecting fish eggs for injecting genes for protein production and so on.

2. Description of the Related Art

Fish eggs such as eggs of zebra fish are preferable for producing useful products by means of injecting genes into fish eggs.
Patent document 1 (PCT unexamined patent publication No. 2001/501,482) describes about an example of the protein production employing fish eggs.

In the gene injection, it is necessary to separate the fertilized eggs from fishes in order to avoid that fishes eat the fish eggs. Patent document 2 (Japan Unexamined Patent Publication No. 2001-120,110) proposes a reverse-pyramid-shaped water tank having a net, which fishes are not capable of passing through. The fish eggs are collected at a lower portion of the water tank by means of water stream flowing downward.

However, there is alien substance such as excrement of fishes in the water tank. Furthermore, the alien substance accumulates in a bottom portion of the water tank. As a result, the separation of the fish eggs from the alien substance becomes difficult. Excrement of fishes has a possibility accompanying harmful bacteria or virus for the gene manipulation. Therefore, the fish eggs have to be collected after they were separated from the alien substance.

A technology capable of separating fish eggs from the alien substance with sufficient separation accuracy is not known yet. Accordingly, the fish eggs are collected with manual labor of a large number of expert workers. However, fish egg is very small, for instance, eggs of zebra fish has longer diameter of the 0.7-1.4 mm. A membrane of fish eggs is soft and thinly. Therefore, the collecting work with tweezers is not easy.

Gene material is injected into the fish egg through a needle inserted into the fish egg. The above gene injection technology is called the injection method. It is necessary for the fish egg to be supported for stability in order to prevent a needle-inserting error.

A fish-egg-holding plate for holding a large number of fertilized eggs is known. A large number of concave portions are formed on the top surface of the fish-egg-holding-plate. Hemisphere-shaped concave portions are arranged like a two-dimensional-matrix on the fish-egg-holding-plate. Each bottom portion of the concave portions communicates to a lower surface of the fish-egg-holding-plate via each through-hole. The through-hole has a diameter through which fish eggs cannot pass. The fish eggs upper the fish-egg-holding-plate are caught in the concave portions, when water in the concave portions is absorbed downward through the through-holes.

However, the conventional fish-egg-holding-plate having shallow concave portions has a problem that the fish egg in the concave portion jumps out of the concave portion outside easily, when the fish-egg-holding-plate is moved. On the contrary, the conventional fish-egg-holding-plate having deep concave portions has a problem that a plurality of fertilized eggs is dropped in one concave portion. Furthermore, there is the problem that the fish egg jumps out of the concave portion by the stabbing of a needle.

The patent document 3 (Japan Unexamined Patent publication No. 2007-222, 132) describes to prevent that the fish egg in the concave portion jumps out of the concave portion by means of narrowing an aperture of the concave portion capable of accommodating only one fertilized egg. Strong negative pressure is given in the concave portion, only when the fish egg is accommodated in the concave portion. The fish egg, which is transformed by the strong pressure, passes through the narrow aperture of the concave portion.

However, the fish egg must be transformed greatly, when the fish egg passes through the aperture of the concave portion. As a result, the membrane of the fish egg is often damaged. Furthermore, a wall portion around the aperture of the concave portion injures the membrane of the fish egg.

Furthermore, it needs a long time for accommodating the fish eggs in all concave portions of the fish-egg-holding-plate, because the apertures of the concave portions are narrow. An allowable time from the laying of eggs to the needle injection is short, for example less than one hour, because dividing of the fertilized egg, such as the fertilized egg of the zebra fish with a large generation speed, is started immediately. After all, it is difficult to employ the fish-egg-holding-plate having the concave portion with the narrow aperture for actual production.

Furthermore, there is a problem that the other fish egg adheres to the fish egg accommodated in the concave portion. Consequently, the current injection technology is operated with only hand works of expert workers, because the problems mentioned above are not solved yet. As a result, it is difficult to use practically the protein production employing the fertilized fish eggs.

### SUMMARY OF THE INVENTION

(Object of the Invention)

An object of the present invention is to realize an apparatus of collecting fertilized eggs having superior productivity, simplicity and safety for gene injection.

(Feature of the Invention)

The fertilized-eggs-collecting-apparatus of the present invention employed for the gene injection is explained below. The apparatus of the present invention has three features explained as follows. As for the first feature of the present invention, an illumination of a water tank is increased in synchronization with at a predetermined egg-laying-scheduled-time. As for the second feature of the present invention, a fertilized-eggs-holding-plate with concave portions for accommodating fertilized eggs separated from water stream is accommodated in a shallow case with an upper aperture. As for the third feature of the present invention, the concave portions of the fertilized-egg-holding-plate are covered with a shutter. It is suitable that the above three inventions are carried out together as the fertilized-egg-collection-apparatus for gene injection. Each of the inventions is explained below.

(The Explanation of the First Invention)

The first invention has a water tank, an egg separation means, an egg collection means and an illumination control means. The egg separation means separates fertilized eggs laid in the water tank from fishes. The egg collection means collects the fertilized eggs from the water tank. The illumination control means increases an illumination of the water tank just before a predetermined egg-laying-scheduled-time. The fish lays eggs when the illumination the water tank is increased. According to the invention, the egg collection means can operate an egg-collection-operation effectively, because the starting of laying eggs is in synchronized with the egg collection.

According to the first embodiment, the egg collection means starts to collect the fertilized eggs in synchronization with increasing of the illuminating. It can be hereby prevented that the collection of the fertilized eggs is operated before the laying of the eggs by means of the increasing the illumination. The egg collection executed before laying eggs causes the collection of alien substances such as feces resembling fertilized eggs. As a result, it is prevented that unfavorable genes such as the bacteria accompanying to the alien substance are injected later into the fertilized eggs.

According to the second embodiment, the illumination control means increases the illumination in the water tank urgently in order to promote the laying of eggs. It is capable of improving with the probability of the laying of eggs by means of increasing the illumination urgently. It seems that the laying of eggs is influenced by the photosensitivity of fish.

According to the third embodiment, outer lighting is shielded during a predetermined time before the illumination is increased. In other words, the illumination that is almost equal to the illumination in night is given to the water tank. Preferably, the illumination is kept for about 10-14 hours after the illumination in the water tank is increased. Then, the illumination is decreased for 14-10 hours. Preferably, the lighting is stopped. Therefore, it is capable of giving the illumination to the fishes, which is almost equal to natural environment.

According to the fourth embodiment, the egg separation means has a net and drainage means for separating fishes. The net disposed at an intermediate portion of the water tank in a height direction of the water tank has apertures capable of passing fertilized eggs and capable of stopping fishes. The drainage means drains water including the fertilized eggs from the bottom portion of the water tank at least for a predetermined period just after increasing the illumination. The egg collection means collects the fertilized eggs from the drainage. In other words, it is realized with easy structure to separate the fertilized eggs from fishes and to collect the fertilized eggs from water stream by means of employing water stream passing through the net and the egg collection means.

According to the fifth embodiment, the drainage drains the alien substances in the water tank just before the illumination is increased. Accordingly, it can be prevented that the alien substances remaining in the water tank before increasing the illumination is collected with the fertilized eggs by means of the egg collection executed after the increasing of the illumination.

According to the sixth embodiment, the drainage means has an alien-substance-collection-conduit, a fertilized-egg-collection-conduit and a drainage-changing-means. The alien-substance-collection-conduit passes the drainage drained from the water tank into an alien substance collection means for collecting the alien substance. The fertilized-egg-collection-conduit diverging from the alien-substance-collection-conduit passes the water in the water tank through the fertilized egg collection means. The drainage-changing-means drains the water in the water tank into either one of the alien-substance-collection-conduit and the fertilized-egg-collection-conduit. The fertilized egg collection means passes the water in the water tank through the fertilized-egg-collection-conduit for a predetermined period just after the illumination is increased. Therefore, the fertilized-egg-collection-conduit can be kept cleanly, because the alien substance flowing into the fertilized-egg-collection-conduit can be reduced.

According to the seventh embodiment, the drainage means has the drainage conduit draining water outside from the water tank. The fertilized egg collection means has a fertilized egg collection container having a passage passing the water and stopping the fertilized eggs. The fertilized egg collection container capable of removing is disposed in the middle portion of the drainage conduit. Therefore, the fertilized egg collection container can be attached to the drainage conduit only for a predetermined period just after the illumination is increased. It is prevented that the fertilized egg collection container is polluted by the alien substance flowing through the drainage conduit by means of removing the fertilized egg collection container from the drainage conduit after the above predetermined period.

(Additional Explanation of the First Invention)

Features and effects of the first invention are explained more concretely as follows. According to the feature of the first invention, the fertilized egg collection is synchronized with the timing when the water tank is lighted up. Accordingly, it can be largely reduced that the alien substances such as feces or bait in the water tank are mixed with the fertilized eggs into the fertilized egg collection means. The genetic pollution of the collected fertilized eggs can be reduced.

More concrete explanation is described below. Fishes, for example one pair or two pairs of zebra fishes of male and female are accommodated in the water tank. It is known that zebra fish is preferable for the protein production. This kind of fishes lays eggs and plays fertilization by increasing illumination of lighting. Therefore, the water tank is kept in clean condition that the alien substances are removed for example by means of circulating water of the water tank constantly. Next, water in the water tank is sent into the fertilized-egg-collection-conduit for a predetermined period (for example about 30 minutes) just after laying eggs by increasing the illumination in the water tank.

The fertilized egg collection conduit mentioned above diverges from the alien-substance-collection-conduit and passes water of the water tank into the fertilized egg collection means. The fertilized-egg-collection-conduit can include an embodiment of collecting water from a water tank directly. It is known that fish such as zebra fish lays eggs and take fertilization action by means of the rapid increasing of the illumination. However, an idea is not proposed that the fertilized egg with a little quantity of the alien substance can be sent to the fertilized egg collection means by means of collecting the fertilized egg at timing in synchronization with turning-on a lighting apparatus. For example, nets can be adopted for the fertilized egg collection means.

Preferably, a large number of water tanks are sorted by a plurality of water tank groups. Each of the water tank groups is lighted up with the lighting apparatus individually. The drainage-changing means changes drainage of the water tank groups individually. The illumination control means lights up each water tank group in turn every predetermined period. The illumination control means changes the drainage of the water tank group where the lighting is started in synchronization with the lighting timing of each water tank group from the alien-substance-collection-conduit to the fertilized-egg-collection-conduit for a predetermined time just after the lighting.

According to this embodiment, the works such as collecting the fertilized eggs and the injection, and so on can be dispersed, because the laying of eggs is executed in turn every each water tank group. It is needed to finish the genetic injection in a short term, for example less than 30 minutes, before the progress of cell division of fertilized eggs. As a result, a gene injection apparatus having a small processing capacity cannot complete the gene injection, if the egg-laying actions in each water tank are executed at the same time. A gene injection apparatus with a high processing capacity is expensive. According to this embodiment, a large number of fertilized eggs can be treated with a fertilized egg processing system with small processing capability.

According to another preferred embodiment, the water tank has reverse-conic-shape or reverse-oval-conic-shape. Therefore, frequent cleaning of the water tank can be prevented, because it can be prevented that a fertilized egg is caught on a corner region of the water tank and stays in the water tank for a long time. It is not easy for the fertilized egg to fall down by the gravity, because the fertilized egg has almost equal specific gravity to water.

According to another preferred embodiment, the fertilized-egg-collection-conduit is extended upward than the horizontal direction from the alien-substance-collection-conduit. Therefore, it can be prevented that the alien substance falls into the fertilized-egg-collection-conduit side during draining the alien substance with the drainage from the water tank to the alien-substance-collection-conduit, and it is prevented that the alien substance drifts to the fertilized egg collection apparatus later.

According to another preferred embodiment, throwing bate into the water tank for catching the fertilized eggs is not executed within twelve hours after the lighting. It can be prevented that the alien substance flows into the fertilized-egg-collection-conduit by means of the turning-on the lighting at the timing when the excretion quantity is as little as possible well, because this kind of fishes excrete within a predetermined time after the eating of bait.

According to another embodiment, the fish isolation net as the fertilized egg separation means has apertures with a size of 1.5-4 times of the fertilized eggs, and is arranged diagonally. A bottom portion of the net is connected to the alien substance collection apparatus. Therefore, the multi-aperture member for isolating fishes can separate fishes from the fertilized eggs falling down with descent water stream in the water tank. Furthermore, the alien substance, which is bigger than the fertilized eggs, can be separated from the fertilized eggs falling down, too.

According to another preferred embodiment, a fertilized-egg-collecting-net for collecting the fertilized eggs is placed diagonally beneath the fertilized-egg-separating-net with a large number of apertures for separating the fertilized eggs. A bottom portion of the fertilized-egg-collecting-net is connected to the fertilized-egg-collection-conduit. It is suitable that apertures of the fertilized-egg-collecting-net have a size of 0.3-0.9 times of the diameter of the fertilized egg. Therefore, collected fertilized eggs become clean, because the fertilized eggs are separated from both of most of drainage collected from the water tank and the alien substances, which are smaller than the fertilized eggs.

According to another preferred embodiment, the bottom portion of the water tank is formed diagonally and is connected to an alien substance collection apparatus. Accordingly, the small alien substances included in the descending water, which passes through the fertilized-egg-collecting-net can be drained after separating from the fertilized eggs.

According to another preferred embodiment, the lighting apparatus outputs ultraviolet light spectrum and visible light spectrum. It is possible to employ white light LEDs including UV light LEDs as the lighting apparatus. The lighting illuminating one water tank group or one water tank should be shielded in order that the light with a level affecting the laying action leaks in the other water tank group or the other water tank. Therefore, it is possible to reduce bacteria increasing on a wall surface of the water tank and in water by means of sterilization effect of the UV light. Furthermore, it is possible to give the environment that is almost natural environment to fishes. The LED lighting apparatus can be placed in the water tank.

According to another preferred embodiment, the water flowing out from the alien substance collection apparatus returns to the water tank, after the water is sterilized. A number of bacteria included in the circulation water can be hereby reduced. A liquid sterilizer of ultraviolet light type or known various apparatuses can be adopted as the sterilizer.

According to another preferred embodiment, cleaned water flowing out from the alien substance collection apparatus flows to the fertilized egg collection means in a term when the drainage flows through the alien-substance-collection-conduit. The water drained out from the fertilized egg collection means can be return to the water tank. Therefore, it is reduced that undesirable genes are injected to the fertilized egg by means of the gene-injection to the fertilized egg, because the fertilized egg caught by the fertilized egg collection means can be protected with clean water. Furthermore, it is prevented that bacteria increases on the fertilized egg collection means and the fertilized-egg-collection-conduit, because fertilized egg collection means and the fertilized-egg-collection-conduit are washed with the cleaned water.

(Explanation of the Second Invention)

A feature of the fertilized egg collection apparatus of the second invention is that a box-shaped case with an upper aperture holds a fertilized-egg-holding-plate. A large number of concave portions with a size capable of accommodating only one fertilized egg each are arranged on one major surface of the fertilized-egg-holding-plate. The water flowing from an aperture of the concave portions into the concave portions is drained out from a through-hole of a bottom portion of the fertilized-egg-holding-plate outside. The through-hole has a size of capable of stopping the fertilized egg. As a result, the fertilized eggs included in the water are caught in the concave portion.

A sided wall of the case supports a penumbra of the fertilized-egg-holding-plate at the position apart from the bottom portion of the case. Therefore, drainages drained out through each through-hole from each concave portion are collected in a drainage room formed between the fertilized-egg-holding-plate and the bottom portion of case. The case has a drainage aperture for draining out the water of the drainage room outside. According to this invention. The catching probability of each concave portion is equalized, because each speed of the water stream passing through each concave portion of the fertilized-egg-holding-plate becomes mostly equal to each other. Furthermore, safe handling of the fertilized-egg-holding-plate is enabled, because the case prevents that the fertilized eggs held in the case attach air.

According to the first embodiment, the fertilized-egg-holding-plate capable of removing the case is held with the case. Therefore, pollution by bacteria in the drainage room can be prevented, because the case can be washed, after the fertilized-egg-holding-plate removes the case. According to the second embodiment, a sided wall of the case has a pedestal portion on which a penumbra of the fertilized-egg-holding-plate is put. Therefore, it becomes easy to support the fertilized-egg-holding-plate by the case, and to remove the fertilized-egg-holding-plate from the case. According to the third embodiment, the sided wall is formed with a predetermined distance higher than the fertilized-egg-holding-plate. As the result, it is prevented that the water drifts around rapidly, when the water including the fertilized eggs is drained on the fertilized-egg-holding-plate from an upper position of the case.

(Explanation of the Third Invention)

A feature of the third invention is to dispose a shutter plate to the fertilized-egg-holding-plate. A large number of concave portions having the size that only one fertilized egg can be accommodated each are arranged on one major surface of the fertilized-egg-holding-plate. Water in the concave portion, which is flowed in the concave portion from the aperture of the concave portion, is drained out of the through-hole of the bottom portion of the fertilized-egg-holding-plate. The through-hole has a diameter capable of stopping for the fertilized egg to pass through. As a result, the fertilized egg included in the water is caught in the concave portion.

The shutter plate is arranged in parallel and adjacent to the above fertilized-egg-holding-plate. The shutter plate can move in parallel to the fertilized-egg-holding-plate. The concave portions of the fertilized-egg-holding-plate are closed by means of shifting the shutter plate, and the fertilized eggs are not capable of moving outside from the concave portions.

According to this invention, it is prevented that the fertilized eggs falling in the concave portions jump out of the concave portions again, because the apertures of the concave portions accommodating the fertilized eggs are covered with the shutter plate. Such jumping out of the fertilized egg often occurs at the time of the handling of the fertilized-egg-holding-plate. Furthermore, it is reduced that various germs stick to the fertilized eggs in the concave portions from outside, because the concave portions are covered with the shutter plate.

According to the first embodiment, the shutter plate has fertilized-egg-passage-apertures at the same positions as the concave portions of the fertilized-egg-holding-plate. The fertilized egg can pass through the fertilized-egg-passage-aperture. Therefore, the shutter plate can close the concave portions by means of slightly moving the shutter plate.

According to the second embodiment, the diameter of the fertilized-egg-passage-aperture is less than one-half of a distance between two fertilized-egg-passage-apertures adjacent to each other in the movement direction of the shutter plate. Therefore, the concave portions can be closed only by moving the shutter plate for a distance, which is equal to only about one-half of the pitch of the fertilized-egg-passage-apertures.

According to the third embodiment, the fertilized-egg-holding-plate and the shutter plate are accommodated in a box-shaped case of which an upper end is opened. A sided wall of the case supports a penumbra of the fertilized-egg-holding-plate at a position apart from a bottom portion of the case. The case has a discharge aperture draining the water of the drainage room formed between the fertilized-egg-holding-plate and the bottom portion of the case. Accordingly, the effects of the second invention are increased.

According to the fourth embodiment, the injection means having a needle for injecting genes in the fertilized egg is provided. The needle is inserted into the fertilized egg through the fertilized-egg-passage-aperture of the shutter plate. In the other words, the fertilized-egg-passage-aperture of the shutter plate serves as a needle-inserting aperture for the gene injection. Therefore, the shutter plate prevents that the fertilized egg in the concave portion is moved toward the aperture of the concave portion from the concave portion by the needle inserted in the concave portion. Success probability of the gene injection hereby is improved.

(Additional Explanation of the Second Invention and the Third Invention)

A feature of the third invention is that the shutter plate opening and closing the aperture of the concave portion of the fertilized-egg-holding-plate is provided. For example, the fertilized eggs of zebra fish can be adopted as the fertilized eggs. However, the other kind of the fertilized eggs can be adopted. Any fertilized eggs can be adopted, if the fertilized eggs are capable of the gene manipulation by the micro-injection, and is capable of operating with liquid (for example, water).

The fertilized egg is guided into the concave portion of the fertilized-egg-holding-plate with the water flowing through the through-hole from the aperture side of the concave portion. The concave portions are arranged like the two-dimension-matrix and are adjusted to the needle positions of the injection apparatus. Therefore, collected fertilized eggs can be held with stability at the needle position until injection of the genes. As the result, the micro-injection with the needle (a slight fine needle) can be carried out precisely.

The feature of the second invention is to adopt the case holding the fertilized-egg-holding-plate. The case has the drainage room and the discharge aperture. The drainage room collects water drained from the bottom portions of the concave portions of the fertilized-egg-holding-plate. The discharge aperture drains the water in the drainage room outside.

Therefore, a large number of the concave portions of the fertilized-egg-holding-plate can catch the fertilized eggs well. The fertilized-egg-holding-plate and the case are formed with one body. The fertilized-egg-holding-plate and the case may be formed separately.

The water including the fertilized eggs should be spread on all of one major surface of the fertilized-egg-holding-plate. The fertilized-egg-holding-plate can have various kinds of postures instead of the horizontal arrangement. It is preferable that the shutter plate can be held and slides on the fertilized-egg-holding-plate or the case. The water on the fertilized-egg-holding-plate falls down to the drainage room of the case through the concave portions and the through-holes with gravity and the drainage of the drainage room. The water stream flowing through the concave portion where the fertilized egg is dropped into is stopped by the fertilized egg.

### BRIEF DESCRIPTION OF THE DRAWINGS

FIG. 1 is a schematic plan view showing a water tank arrangement of a fertilized egg collection apparatus of the embodiment 1.

FIG. 2 is a block diagram showing the fertilized egg collection apparatus shown in FIG. 1.

FIG. 3 is an enlarged schematic cross-section showing a drainage-changing portion shown in FIG. 1.

FIG. 4 is a block diagram showing the fertilized egg collection apparatus of the embodiment 2.

FIG. 5 is a schematic cross-section showing the water tank structure of the fertilized egg collection apparatus of the embodiment 3.

FIG. 6 is a schematic perspective view for explaining the principle of the fertilized egg collection apparatus of the embodiment 4.

FIG. 7 is a partially enlarged cross-section showing around the concave portion of the fertilized-egg-arranging-plate shown in FIG. 6.

FIG. 8 is a schematic perspective view showing the essential part of the fertilized egg collection apparatus having a fertilized-egg-arranging-plate shown in FIG. 6.

FIG. 9 is a cross-section showing the apparatus shown in FIG. 8.

FIG. 10 is a longitudinal cross-section of the fertilized egg collection apparatus shown in the embodiment 5.

FIG. 11 is a cross section in the width direction of the fertilized egg collection apparatus shown in FIG. 10.

FIG. 12 is a cross-section in the width direction of the fertilized egg collection apparatus shown in FIG. 10.

FIG. 13 is a schematic cross-section of the fertilized egg collection apparatus of the embodiment 6

FIG. 14 is a schematic cross-section showing a state before collecting the fertilized eggs by the fertilized egg collection apparatus of the embodiment 6.

FIG. 15 is a schematic cross-section showing the fertilized-egg-holding-state of the fertilized egg collection apparatus of the embodiment 6.

FIG. 16 is a schematic cross-section showing a part of the fertilized egg collection apparatus of the embodiment 7.

FIG. 17 is a plan view of a rotary disk shown in FIG. 16.

FIG. 18 is an enlarged cross-section of the rotary disk shown in FIG. 16.

FIG. 19 is a schematic cross-section showing the case of the fertilized egg collection apparatus of the embodiment 8.

FIG. 20 is a schematic cross-section showing the case of the fertilized egg collection apparatus of the embodiment 8.

### DETAILED DESCRIPTION OF THE PREFERRED EMBODIMENT

Preferred embodiments of the fertilized egg collection apparatus of the present invention is explained referring to drawings. The embodiments 1-3 disclose the fertilized egg collection apparatus of light-synchronization type, which consists of the first feature of the present invention. The embodiments 4-6 disclose a fertilized-egg-holding-plate in the case, which consists of the second feature of the present invention, and a fertilized-egg-holding-plate having with a shutter plate, which consists of the third feature of the present invention. In addition, marks employed in the embodiments 1-3 do not have relations with marks employed in the embodiments 4-6 to each other.

### The Embodiment 1

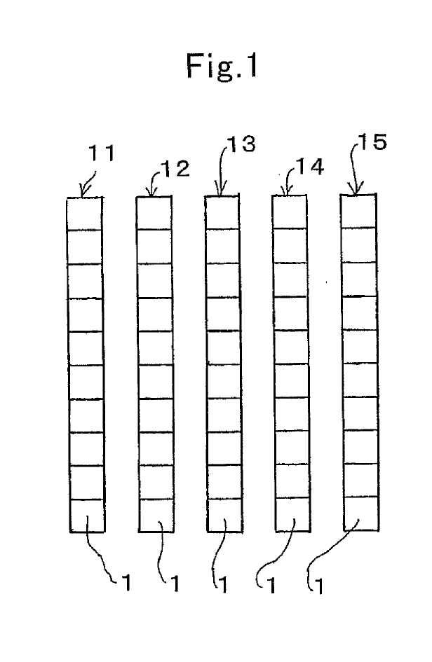

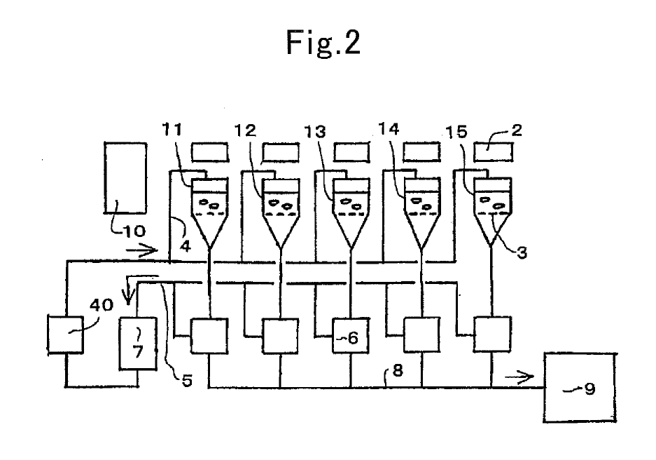

The fertilized egg collection apparatus of the embodiment 1 is explained referring to FIGS. 1 and 2. FIG. 1 is a schematic plan view showing arrangement of water tanks of the fertilized egg collection apparatus. FIG. 2 is a schematic block diagram of the fertilized egg collection apparatus shown in FIG. 1.

The fertilized egg collection apparatus has fifty water tanks 1 in total, which are arranged in five lines having ten rows each. One pair of male and female of zebra fishes or two pairs of zebra fishes is accommodated in each water tank 1 each. The water tank lines 11-15, called the water tank groups, are arranged like two-dimensional matrix. Each of the water tank lines 11-15 consists of ten water tanks 1 arranged in turn. Five lighting apparatuses 2 in total light up the water tank lines 11-15 individually. Each lighting apparatus 2 is disposed upper each water tank lines 11-15. Each lighting apparatus 2, which is a waterproofed LED apparatus, consists of a large number of white LEDs and a few ultraviolet ray LEDs. Each of five lighting apparatus 2 lights up only the water tank line with a just under position.

Each water tank line is covered each with a light shield wall (not illustrated).

An upper half portion of the water tank 1 has rectangular-barrel-shape. A lower half portion of the water tank 1 has a cone shape or oval-cone shape, which becomes narrowing downward. A net 3 is disposed at an intermediate position of water tank 1 in the height direction. Zebra fishes are accommodated in the upper space than the net 3, which constitutes the fertilized egg separation means. The net 3 has apertures through which the fertilized eggs can pass, and zebra fish is not capable of passing.

A water supply pipe 4 supplies water pressurized by a pump to each water tank 1 each. An alien-substance-collection-conduit 5 drains water in each water tank from bottom portions of each water tank 1. The alien-substance-collection-conduit 5 sends drainage to an alien substance collection apparatus 7 through drainage-changing-portion 6, which constitutes the changing means-means. The alien substance collection apparatus 7 collects alien substances from drainage flowing in.

The water cleaned by the alien substance collection apparatus 7 is sent to the pump 40 after it was sterilized. The alien substance collection apparatus 7 consists of a filter of filtering alien substances, and an ultraviolet-ray-sterilizer sterilizing the water flowed out of the filter.

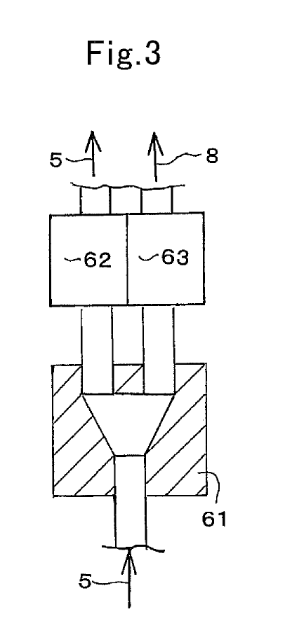

A fertilized-egg-collection-conduit 8 diverges from the drainage-changing-portion 6, and sends drainage to a fertilized egg collection portion 9, which is the fertilized egg collection means. Fertilized egg collection portion 9 consists of a net for collecting fertilized eggs. The details of drainage-changing-portion 6 are explained referring to FIG. 3. FIG. 3 is a front elevation showing the drainage-changing-portion (the changing means) 6. The drainage-changing-portion 6 consists of a divergence joint 61, a valve 62 and 63. The divergence joint 61 is disposed in an intermediate portion of the alien-substance-collection-conduit 5. The valve 62 opens and closes the alien-substance-collection-conduit. The valve 63 opens and closes the fertilized-egg-collection-conduit.

An upper stream portion of the alien-substance-collection-conduit 5 is connected to a bottom aperture of the divergence joint 61. A down stream portion of the alien-substance-collection-conduit 5 is connected to one upper aperture of the divergence joint 61. The down stream portion of the alien-substance-collection-conduit 5 sends drainage to the alien substance collection apparatus 7 through the valve 62. Another upper aperture of the divergence joint 61 is connected to the fertilized-egg-collection-conduit 8. The fertilized-egg-collection-conduit 8 sends fertilized eggs to the fertilized egg collection portion 9 through the valve 63.

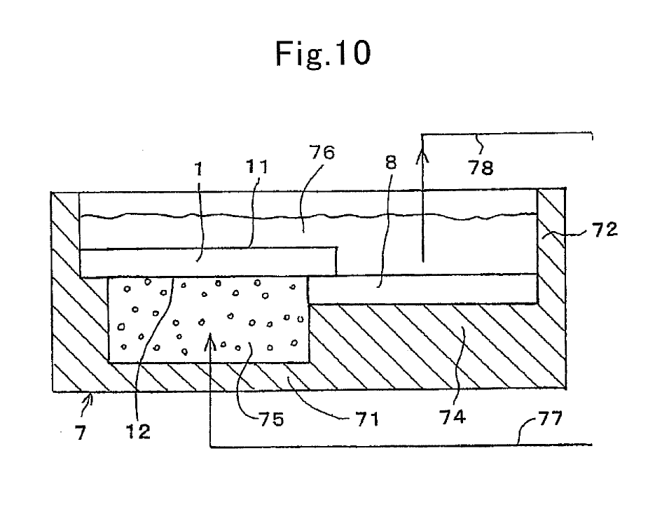

Valves 62 and 63 consist of electromagnetic pinch valves, which open and close by means of sandwiching and removing silicon rubber tubes in accordance with electrical signals. Valves 62 and 63 controlled by a controller 10, which are the control means, are shown in FIG. 10. Valves 62 and 63 open and close the fertilized-egg-collection-conduit 8 and the down stream portion of the alien-substance-collection-conduit 5. In addition, valve 62, 63 may consist of conventional electromagnetic valves. The controller 10 serves as an illumination control means.

(Operation)

The operation of the apparatus controlled by controller 10 is explained below.

### (Control of Laying Eggs)

Controller 10 lights up each of the water tank lines 11-15 for every predetermined time by means of controlling each of the lighting apparatuses 2. A turning-on period of each water tank line 11-15 is 12 hours. A turning-off period is 12 hours, too.

The ultraviolet rays emitted from the ultraviolet LED included in the lighting apparatus 2 restrain bacterial breeding on a inner surface of the water tank and a surface of the net 3, and restrain bacteria falling down to a water surface in the water tank 1. An amount of the ultraviolet rays is the level that does not give bad influence to the egg-laying action of zebra fishes. Therefore, it is restrained that these bacteria stick on the fertilized eggs.

Five lighting apparatuses 2 are performed in turn with each time lag of about one hour. Therefore, the works of collecting the fertilized eggs, arranging the fertilized eggs and the injecting of the genes are dispersed. For example, 24 lines of the water tank lines are established, if the large-scale production is executed. Accordingly, the later fertilized-egg-processing-work is carried out hourly.

(The Valve Control)

Pump 40 always supplies water, which is cleared by the alien substance collection apparatus 7, to fifty water tanks 1 in total.

In other words, the water circulates between the water tank 1 and the alien substance collection apparatus 7 through the alien-substance-collection-conduit 5. A known filter apparatus or ultraviolet-ray-sterilizer built-in to the alien substance collection apparatus 7 are adopted for cleaning of the water.

The alien substances such as feces generated in each water tank 1 are collected to the filter of the alien substance collection apparatus 7 through the alien-substance-collection-conduit 5. Therefore, there is hardly the alien substance in each of water tanks 1. The feeding to zebra fishes is performed once in 24 hours just after the collection of the fertilized eggs in the water tank 1 has been completed. An existence probability of the alien substance in the water tank 1 at the fertilized egg collection becomes smallest, because excretion of zebra fishes tends acting to be performed after the feeding.

Controller 10 outputs instructions to close the valve 62 and to open the valve 63, which belong to the water tank line on which the lighting has been started. As a result, the drainage of the water tank line on which the lighting has been started is sent to the fertilized egg collection portion (the fertilized egg collection means) 9 through the fertilized-egg-collection-conduit 8 from the drainage-changing-portion 6.

The fertilized egg collection portion 9 consists of the net for collecting the fertilized eggs. The drainage passing through the net is sent to the alien substance collection apparatus 7. The fertilized egg collected in the net, which constitutes the fertilized egg collection portion 9, is sent to a gene injection processor by using a conduit with a valve. The gene injection process can be done in the fertilized egg collection portion 9.

Next, controller 10 closes the valve 63, and opens the valve 62 after predetermined time, (for 30-40 preferably), later from starting of the lighting. As a result, the drainage of the water tank line is sent to the alien substance collection apparatus 7. It is restrained that the alien substance is mixed in the fertilized egg collection portion 9, and that bacteria sticks to the fertilized eggs and the water. As a result, the gene injection into the fertilized eggs is performed with sanitary, because it is reduced that a needle for injection is polluted with bacteria and alien substances.

The fertilized-egg-collection-conduit 8 extends upward from the divergence joint 61 of the drainage-changing-portion 6. As a result, it is restrained that the alien substance reaching in the divergence joint 61 from the upper stream portion of the alien-substance-collection-conduit 5 stays in the fertilized-egg-collection-conduit 8. In addition, the down stream portion of the alien substance collection apparatus 7, which extends from the divergence joint 61, can be disposed under the divergence joint 61. The upper stream portion of the alien-substance-collection-conduit 5 can be established upper the divergence joint 61. According to the embodiment, the existence probability of alien substance in the water tank at the time when the fertilized egg collection is started is decreased, because the feeding is performed just after completion of collecting the fertilized egg.

### The Embodiment 2

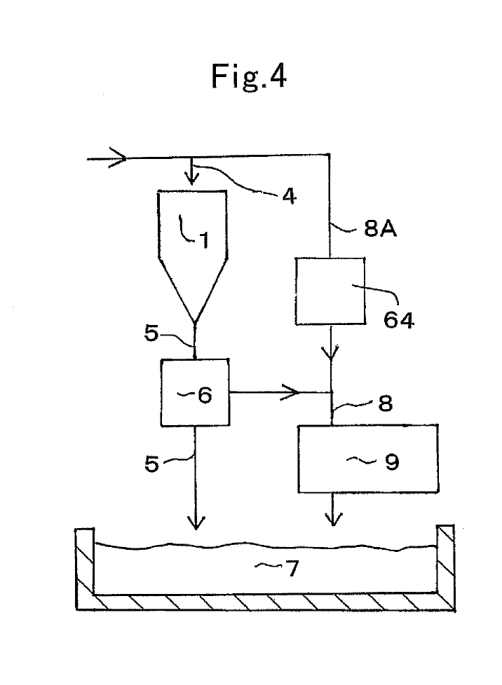

The fertilized egg collection apparatus of the embodiment 2 is explained referring to FIG. 4. FIG. 4 is a schematic block diagram showing the fertilized egg collection apparatus. Only different points from the embodiment 1 are explained, because this fertilized egg collection apparatus is essentially same as it of the embodiment 1. The fertilized egg collection apparatus shown in FIG. 4 has the water tank 1, the lighting apparatus (not illustrated), the net for separating fertilized eggs (not illustrated), the water supply pipe 4, the pump (not illustrated), the alien-substance-collection-conduit 5, the drainage-changing-portion 6, the alien substance collection apparatus 7, the fertilized-egg-collecting-conduit 8 and the fertilized egg collection portion 9. It is similar to the embodiment 1.

Furthermore, the fertilized egg collection apparatus has a valve 64 and a water-supply-conduit BA for collected fertilized eggs. The water-supply-conduit 8A supplies cleaned and sterilized water to the fertilized egg collection portion 9 through the pump mentioned above. The valve 64 controls the water supply of the water supply conduit 8A. Actually, water supply conduit 8A consists of an extension portion of the water supply pipe 4 for supplying water to the water tank 1.

The fertilized egg collection portion 9 has a net (not illustrated) for collecting the fertilized eggs. The net is accommodated in the water tank having an upper aperture. The water overflowing from the fertilized egg collection portion is returned to the water-tank-shaped alien substance collection apparatus 7. In other words, the fertilized eggs flowed into the fertilized egg collection portion 9 from the drainage-changing portion 6 through the fertilized-egg-collection-conduit 8 are collected by the net disposed in the fertilized egg collection portion 9. The collected fertilized eggs are washed with the clean sterilized water, which is always supplied in the fertilized egg collection portion 9 from the water-supply-conduit 8A. Moreover, the collected fertilized eggs are protected from by contact with air. The alien substance, which is smaller than the fertilized eggs, is drained to the alien substance collection apparatus 7 after passing the net, because the net of the fertilized egg collection portion 9 has apertures through which the fertilized eggs is not capable of passing.

According to the embodiment 2, the fertilized eggs collected in the fertilized egg collection portion 9 are always washed with the clean sterilized water, and is protected. As a result, the pollution of the fertilized eggs is prevented. A filter is installed in the water tank 7, which is the alien substance collection apparatus. The water passing through the filter is returned to the water-supply-pipe 4 through the ultraviolet-ray-sterilizer (not shown) by means of using a pump (not shown). This is the same as the embodiment 1.

### The Embodiment 3

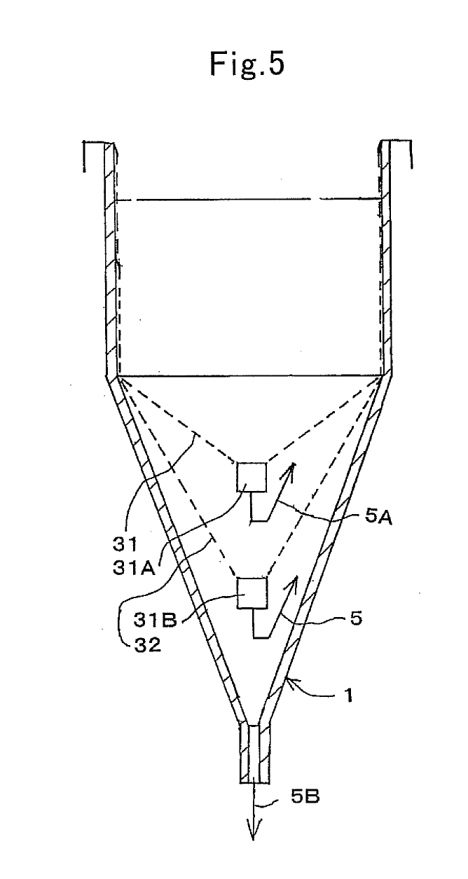

A fertilized egg collection apparatus of the embodiment 3 is explained referring to FIG. 5. FIG. 5 is a schematic vertical cross-section showing the water tank of this fertilized egg collection apparatus. Structure and function of the water tank 1 are explained in detail, because this embodiment is the same as the embodiments 1 and 2 mentioned above except the water tank 1. The water tank 1 shown in FIG. 5 has essentially same structure as the water tank of the embodiment 1. But, the water tank shown in FIG. 5 has nets 31 and 32, which are arranged at an upper position and a lower position instead of the fertilized-egg-separating-net 3 of the embodiment 1.

The upper net 31 has shape of quadrangular pyramid (a reverse pyramid) from an intermediate portion of the water tank as shown in FIG. 5. The net 31, separates fishes and fertilized eggs like the net 3 of the embodiment 1. However, the net 31 prevents the passing of the alien substances including zebra fish, which are bigger than the fertilized eggs. Preferably, the fertilized eggs with a size of 0.7-1.5 mm pass through the apertures of the net 31. The alien substance bigger than the fertilized eggs cannot pass the net 31. Preferably, the apertures of net 31 have a size of 3 mm. A bottom portion 31A of the net 31 is connected directly to the alien substance collection apparatus 7, which is disposed outside, through the alien-substance-collection-conduit 5A. The alien substance prevented the passing by the net 31 is drained to the alien substance collection apparatus 7 through the alien-substance-collection-conduit 5A.

The net 32 has shape of quadrangular pyramid (a reverse pyramid) from an intermediate portion of the water tank as shown in FIG. 5. A large number of the apertures of the lower net 32 have a size of preventing to pass the fertilized eggs. Preferably, the aperture (the stitch) of net 32 has a size of 0.6 mm. Most of alien substances having smaller size than the fertilized eggs pass the net 32, and drift to the bottom portion of the water tank 1. The bottom portion 31B of the net 32 is connected to the drainage-changing-portion 6, which is disposed outside, through the alien-substance-collection-conduit 5.

The bottom portion of the reverse-pyramid-shaped water tank 1 is connected to the alien substance collection apparatus 7 through the alien-substance-collection-conduit 5B. The drainage including the small alien substance is drained to the alien substance collection apparatus 7 through the alien-substance-collection-conduit 5B after passing the lower net 32. The nets 31 and 32 made from metal have upper end portions connected to an upper edge of the water tank 1. The alien-substance-collection-conduits 5A and 5 extend outside across the upper edge of the water tank 1 as well as nets 31 and 32, too. Exits of the alien-substance-collection-conduits 5A and 5 are established downward than inlets of the alien-substance-collection-conduit 5. The water flows by using the siphon effect.

According to the embodiment, the fertilized eggs and the alien substance with similar size like the fertilized eggs are sent to the drainage-changing-portion 6, after passing the upper rough net 31 and stopped by the lower net 32 with the small apertures. As a result, the pollution of the drainage-changing-portion 6, the fertilized-egg-collection-conduit 8 and the fertilized egg collection portion 9 is reduced more. The large alien substance caught by the net 31 and the small alien substance passing through the net 32 are sent to the alien substance collection apparatus 7 directly without going via the fertilized egg collection system. Therefore, the cleanliness of the water tank 1 is maintained.

### The Embodiment 4

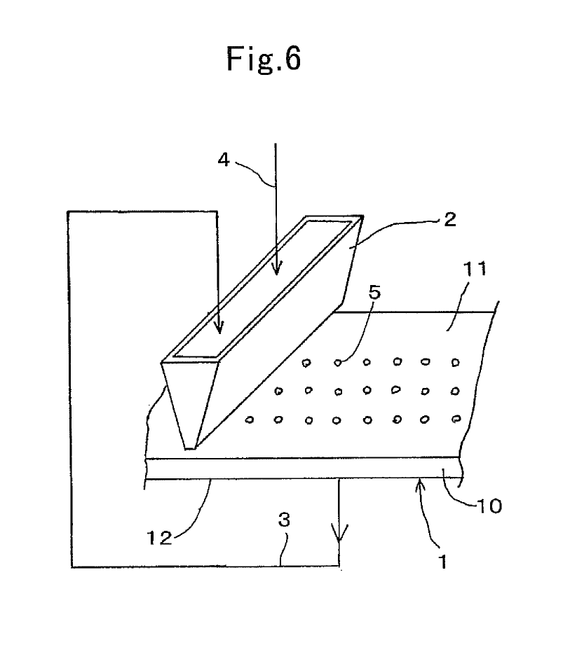

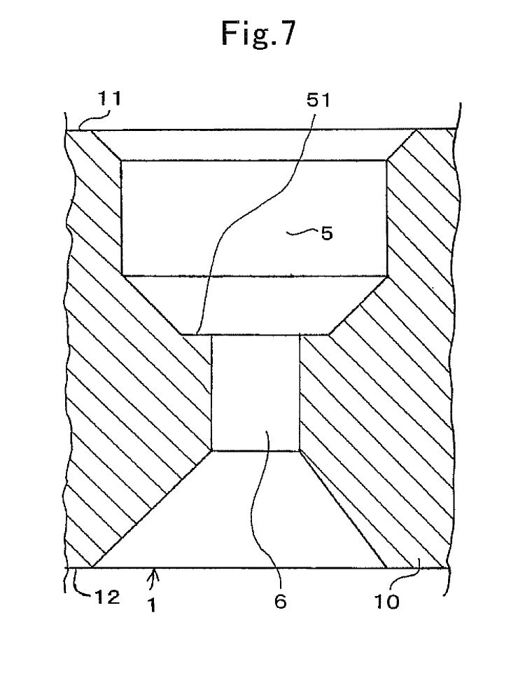

The fertilized egg collection apparatus of the embodiment 4 is explained referring to FIGS. 6-9. FIG. 6 is a schematic perspective view showing the basic constitution of the fertilized-egg-holding-plate of this embodiment. FIG. 7 is an enlarged partial vertical cross-section showing the concave portion around the fertilized-egg-holding-plate shown in FIG. 6.

The fertilized egg collection apparatus shown in FIG. 6 has a fertilized-egg-holding-plate 1, a scatter water tank 2, a return pipe system 3 and a water supply conduit 4. The scatter water tank 2 is a water tank for flowing down water including the fertilized eggs to a top surface of the fertilized-egg-holding-plate 1. The return pipe system 3 returns water drained downward from the fertilized-egg-holding-plate 1 to the scatter water tank 2. The return pipe system 3 installs a pump (not shown). The water supply line 4 supplies water including the fertilized eggs collected by the embodiment 1 to the scatter water tank 2. The water supply conduit 4 supplies water including the fertilized eggs to the scatter water tank 2.

The scatter water tank 2 has a width being mostly equal to a width of the fertilized-egg-holding plate 1. The reverse-trapezoid-shaped scatter water tank 2 is sharpened downward. A bottom portion of the scatter water tank 2 has a long aperture (not shown), which has a mostly equal width to it of the fertilized-egg-holding-plate. The water with the fertilized eggs in the scatter water tank 2 drops down from the long aperture to the top surface of the fertilized-egg-holding-plate 1.

A large number of the concave portions 5 are arranged on the top surface of a flat plate portion 10 of the fertilized-egg-holding-plate 1. The concave portions 5 are arranged like the two-dimensional matrix toward the right direction in FIG. 1 from the scatter water tank 2. The top surface of the fertilized-egg-holding-plate 1 is held mostly horizontally. The top surface may extend diagonally.

Shape of the concave portion disposed on the fertilized-egg-holding-plate 1 is explained referring to FIG. 7. The fertilized-egg-holding-plate 1 has a rectangular-shaped flat plate portion 10. The flat plate portion 10 has an upper surface (one major surface) 11 and a lower surface (the other major surface) 12. The cylinder-shaped concave portion 5 has a shallow bottom. The concave portion 5 has a diameter (preferably about 2 mm), which is a little larger than the largest diameter (1.5 mm) of the fertilized egg. The concave portion 5 has a base 51. The concave portion 5 has a depth (preferably about 1.7 mm), which is a little larger than the largest diameter (1.5 mm) of the fertilized egg. The diameter of the concave portion 5 is decreased downward near the base 51 of the concave portion 5. Sharpness of an upper edge of the concave portion 5 is decreased.

The concave portion 5 can accommodate only one fertilized egg of zebra fish. A through-hole 6 is arranged at a central portion of the base 51 of the concave portion 5. A diameter of the through-hole 6 is smaller than the smallest diameter (for example, 0.7 mm) of the fertilized egg. Preferably, the diameter of the through-hole 6 is 0.2-0.5 mm. A diameter of the tapered lower portion of the through-hole 6 is increased downward. Catching of fertilized egg with using a concave portion 5 and a through-hole 6 is known.

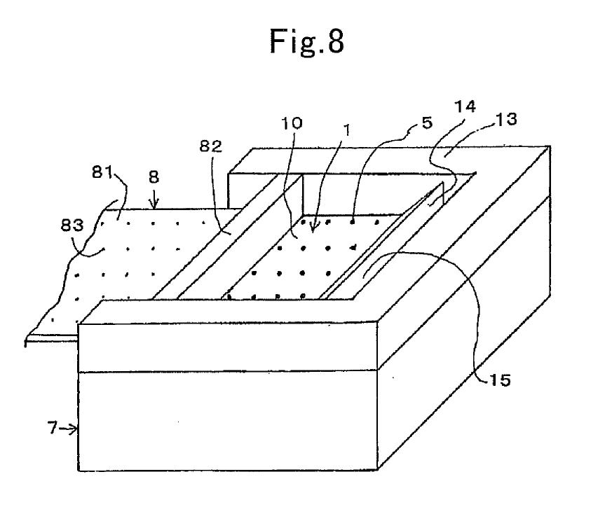

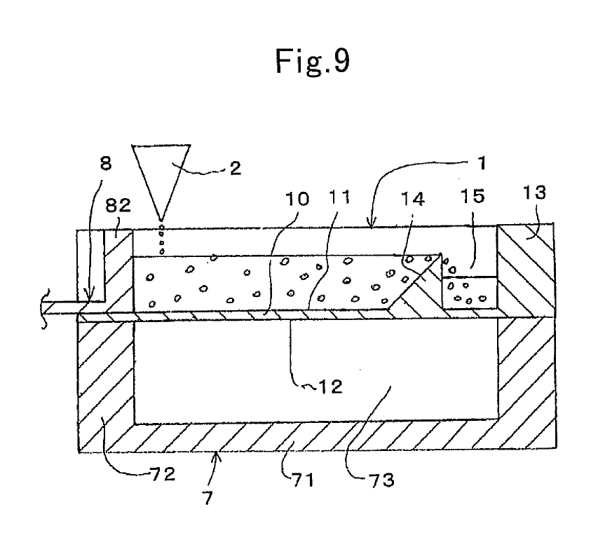

Total structure of the fertilized egg collection apparatus of this embodiment, which includes the fertilized-egg-holding-plate 1, is explained referring to FIGS. 8 and 9. FIG. 8 is a schematic perspective view showing the fertilized egg collection apparatus. FIG. 9 is a vertical cross-section of the fertilized egg collection apparatus shown in FIG. 3. The fertilized-egg-holding-plate 1 has a sided wall 13 extending upward from three sides of the flat plate portion having the concave portions 5 arranged like the two-dimensional matrix. The fertilized-egg-holding-plate 1 has a barrier wall 14 for overflowing. The barrier wall 19 has a height that is lower than the sided wall 13. The concave portion 5 is disposed in the left side than the barrier wall 14 for overflowing.

The space between the C-shaped sided wall portion 13 and the barrier wall 14 for overflowing constitutes a collection concave portion 15 of accumulating water with fertilized eggs, which overflows beyond the barrier wall 14. The water in the collection concave portion 15 is returned to the scatter water tank 2 again through a drainage aperture (not illustrated) established at the C-shaped sided wall 13.

The fertilized egg collection apparatus of this embodiment has a case 7 supporting the fertilized-egg-holding-plate 1. The Case 7 of which an upper end is opened is jointed to a penumbra of the lower portion of the fertilized egg collection apparatus. The case 7 consists of a flat and rectangular bottom plate portion 71 and a rectangular frame portion 72 standing from a penumbra of the bottom plate portion 71. The case 7 has a horizontal cross section, which is mostly equal to the fertilized-egg-holding-plate 1. The upper end surface of the rectangular frame portion 72 of the case 7 adheres to the penumbra of the fertilized-egg-holding-plate 1.

The fertilized-egg-holding-plate 1 is jointed to the case 7. Therefore, a drainage room 73 is sectioned in the case 7 with the rectangular frame portion 72 and the bottom plate portion 71. The upper aperture of the drainage pool 73 is covered by the fertilized-egg-holding-plate 1. The rectangular frame portion 72 of the case 7 has a drainage aperture (not illustrated) for draining water in the drainage room 73.

The fertilized egg collection apparatus of this embodiment has a shutter plate 8. The shutter plate 8 held by the case 7 can slide along the upper surface of the top surface of the fertilized-egg-holding-plate 1. The shutter plate 8 can close the upper apertures of the concave portions 5 of the fertilized-egg-holding-plate 1. The shutter plate 8 has a flat plate portion 81 and a partition wall portion 82 established at a front end portion of the flat plate portion 81. The flat plate portion 81 has a width, which is equal to a width of a space between two portions of C-shaped sided wall 13 of the fertilized-egg-holding-plate 1.

The partition wall portion 82 of the shutter plate 8 has a height that is equal to a height of the C-shaped sided wall 13. The partition wall portion 82 and the sided wall 13 of the fertilized-egg-holding-plate 1 surround the flat plate portion 10 of the fertilized-egg-holding-plate 1. Therefore, water can be accumulated on the flat plate portion 10 of the fertilized-egg-holding-plate 1.

FIG. 9 is a schematic vertical cross-section of the fertilized egg collection apparatus 8, of which the shutter plate 8 is in the opened state. The concave portion of the fertilized-egg-holding-plate is covered by the shutter plate 8, when the shutter plate 8 reaches the barrier wall 14, after the shutter plate 8 slides to the right direction from the above opened state. The sided wall 13 of the fertilized-egg-holding-plate 1 guides the sliding of the shutter plate 8.

The flat plate portion 81 of the shutter plate 8 has a large number of needle insertion apertures 83. In the closed state, in which the shutter plate 8 covers the concave portion 5, needle insertion apertures 83 are located just upper the concave portions 5 of the fertilized-egg-holding-plate 1. The needle of the injection apparatus (not shown) is inserted in the concave portion 5 through the needle insertion aperture 83 in order to the genetic injection to fertilized eggs. The needle insertion aperture 83 is tapered upward for easy needle insertion. For example, an aperture diameter of the needle insertion aperture 83 is 2-4 times of the needle diameter.

The operation of the fertilized egg collection apparatus of the embodiment is explained below. At first, cleaned water is introduced in the drainage pool 73 through an aperture not illustrated) formed through the rectangular-frame portion 72 of the case 7. Therefore, the air remaining in the drainage pool 73, the through-hole 6 and the concave portion 5 of the fertilized-egg-holding-plate 1 is drained upward. Next, water with the fertilized eggs is scattered in the scatter water tank 2, which is the fertilized egg supply portion. The water surface level of the scatter water tank 2 is kept constant by means of overflowing.

The scatter water tank 2 is separated far from the barrier wall 14 for overflowing, and is extended in parallel to the barrier wall 14 for overflowing. The water with the fertilized eggs drops down from the scatter water tank 2, and is accumulated on the top surface of the fertilized-egg-holding-plate 1. The water on the top surface of the fertilized-egg-holding-plate 1 falls in the drainage pool 73 through the concave portion 5 and the through-hole 6 by means of draining water of the drainage pool 73. As a result, the fertilized eggs included in the water are pushed into the concave portion 5.

The shutter plate 8 slides at a stage when the fertilized eggs fell into almost concave portions 5. Shutter plate 8 closes all apertures of the concave portions 5. Each fertilized egg in each concave portion 5 is hereby held surely in each concave portion 5. Furthermore, partition wall portion 82 pushes water on the fertilized-egg-holding-plate 1 to the collection concave portion 15 over the barrier wall 14 for overflowing by means of sliding the shutter plate 8.

Then, a needle (not illustrated) of a known injection apparatus is descended perpendicularly from upper the shutter plate 8. Genes are injected to each fertilized egg. Then, the case having the fertilized-egg-holding-plate is kept at a predetermined constant temperature.

According to this embodiment, it is protected for the fertilized eggs to jump out from the concave portion 5, because the apertures of the concave portions 5 accommodating the fertilized eggs are closed with the shutter plate 8. Furthermore, the needle can be inserted in the fertilized eggs in the concave portions 5 closed with the shutter plate 8, because needle insertion apertures 83 are formed at the shutter plate 8. Therefore, the movement of the fertilized egg by means of forcing of the needle can be prevented.

### The Embodiment 5

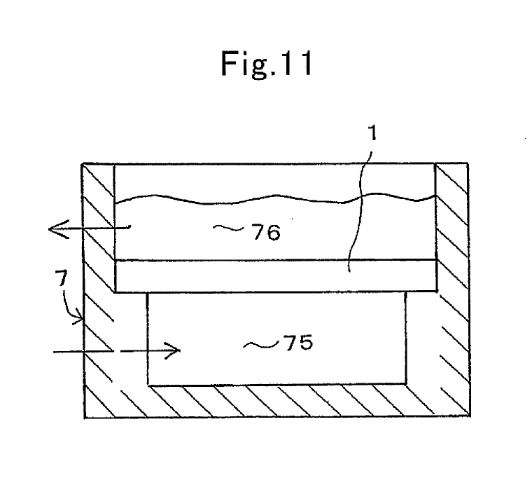

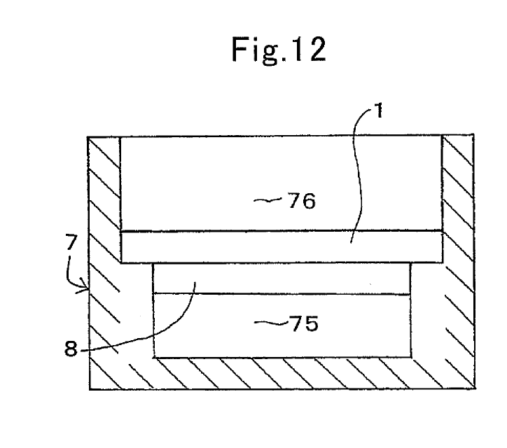

The fertilized egg collection apparatus of the embodiment 5 is explained referring to FIGS. 10-12. FIG. 10 is a longitudinal cross-section showing the fertilized egg collection apparatus. FIGS. 11 and 12 is cross-sections of the fertilized egg collection apparatus, and are cross-sections cut in the width direction. FIG. 11 shows a state that the fertilized eggs are collected. FIG. 7 shows a state that the shutter plate is closed.

This fertilized egg collection apparatus has the fertilized-egg-holding-plate 1, the case 7 and the shutter plate 8. Fertilized-egg-holding-plate 1 is the same as it of the embodiment 4 essentially. The fertilized-egg-holding-plate 1 consisting of a rectangular flat plate has a large number of pairs of the concave portion and the through-hole. The concave portions for catching the fertilized eggs are established like the two-dimensional matrix on a lower surface 12 of the fertilized-egg-holding-plate 1. The through-hole communicates the concave portion and the top surface 11 of the fertilized-egg-holding-plate 1.

The shutter plate 8 contacting on a lower surface 12 of the fertilized-egg-holding-plate 1 is capable of sliding horizontally. But, the shutter plate 8 does not have the needle insertion apertures. The case 7 has a bottom plate portion 71 and a rectangular frame portion 72 standing from a penumbra of the bottom plate portion 71. A stand portion 74 is formed as the right half of the bottom plate portion 71. Shutter plate capable of sliding rides on the stand portion 74. A liquid-absorbing pool 75 is formed at the left half of the bottom plate portion 71.

The liquid-absorbing pool 75 is surrounded with the rectangular frame portion 72 and the stand portion 74. The upper aperture of the liquid-absorbing pool 5 is closed by the fertilized-egg-holding-plate 1. The case 7 has a drainage pool 76 in the upper space of the fertilized-egg-holding-plate 1 and the shutter plate 8. The drainage pool 76 is surrounded with the rectangular frame portion 72. A water supply conduit 77 supplies water with the fertilized eggs from a container (not illustrated) for accumulating the water with the fertilized eggs to the liquid-absorbing pool 75. A drainage pipe 78 drains the liquid from the drainage pool 76 to an alien substance collection apparatus disposed placed outside.

(Operation)

Fertilized-egg-collection operation of the apparatus is explained referring to FIGS. 10 and 11. At first, a water supply conduit 77 supplies water with fertilized eggs into the liquid-absorbing pool 75. The water of the liquid-absorbing pool 75 is drained in the drainage pool 76 through the concave portions of the fertilized-egg-holding-plate 1 and the through-holes.

The fertilized egg in the liquid-absorbing pool 75 approaches the concave portion by rising water stream, and is accommodated in the concave portion. The fertilized egg accommodated in the concave portion is held stably in the concave portion of the fertilized-egg-holding-plate 1. Each concave portion opening downward accommodates only one fertilized egg each. The drainage drained in the drainage pool 76 positioned on the fertilized-egg-holding-plate 1 and the shutter plate 8 is sent through the exhaust pipe 78 to the alien substance collection apparatus placed outside.

Next, the fertilized-egg-holding-operation of the apparatus is explained referring to FIGS. 10-12. The shutter plate 8 closes each aperture of the concave portions by means of sliding the shutter plate 8. Each fertilized egg in the concave portions is held stably in each concave portion. The through-holes for drainage opening on the top surface 11 of the fertilized-egg-holding-plate 1 constitute needle-insertion-apertures for the injection apparatus.

### The Embodiment 6

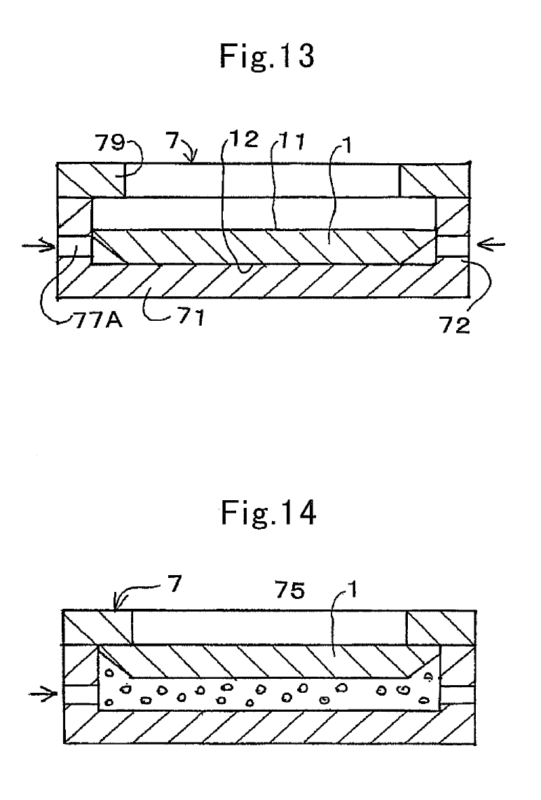

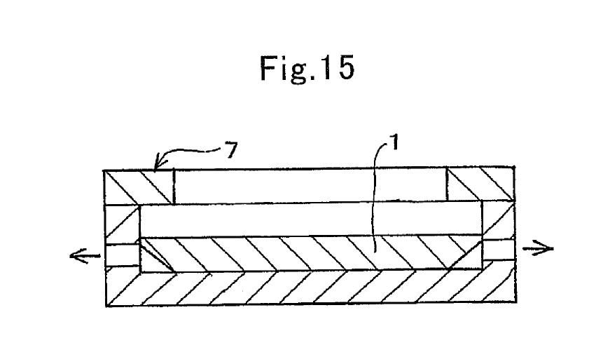

A fertilized egg collection apparatus of the embodiment 6 is explained referring to FIGS. 13-15. FIG. 13 is a cross-section showing a state before the fertilized eggs are collected. FIG. 14 is a cross-section showing a state when the fertilized eggs are being collected. FIG. 15 is a cross-section showing a state of holding the fertilized eggs. This fertilized egg collection apparatus has the fertilized-egg-holding-plate 1 and the case 7. The fertilized-egg-holding-plate 1 is the same as it of the embodiment 5 essentially.

The fertilized-egg-holding-plate 1 has a large number of the concave portions and a large number of through-holes communicating the concave portions. The concave portions for catching the fertilized eggs are established on lower portions 12 of the fertilized-egg-holding-plate 1 like two-dimensional matrix. Each through-hole communicates each concave portion and the top surface 11 of the fertilized-egg-holding-plate 1. The side surface of the fertilized-egg-holding-plate 1 extends diagonally.

The case 7 has a bottom plate portion 71, a rectangular frame portion 72 and a rectangular frame lib 79. The bottom plate portion 71 is a little bigger than the fertilized-egg-holding-plate 1. The rectangular frame portion 72 stands on the penumbra of the bottom plate portion 71. The rectangular frame lib 79 as a stopper surrounds the fertilized-egg-holding-plate 1 from the upper end of the rectangular frame portion 72. The rectangular frame lib 79 projects horizontally. The rectangular frame lib 79 prevents that the fertilized-egg-holding-plate 1 leaves the case 7 upward.

The rectangular frame portion 72 of the case 7 is higher than a sum of the thickness of the fertilized-egg-holding-plate 1 and a predetermined width. The fertilized-egg-holding-plate 1 can be lifted up and down in the case 7. A plurality of water supply apertures 77A is formed through the bottom portion of the rectangular frame portion 72 of the case 7. The water supply apertures 77A supply water with the fertilized eggs in a space under the fertilized-egg-holding-plate 1. The water supply apertures 77A communicates a water supply conduit, which supplies the water with fertilized eggs from a container (not illustrated) accumulating the water with fertilized eggs to a lower space under the fertilized-egg-holding-plate. The drainage pool 76 is formed in an upper space on the fertilized-egg-holding-plate 1. The rectangular frame portion 72 forms a side surface of the drainage pool 76.

(Operation)

At first, the fertilized-egg-holding-plate 1 is on the bottom plate 71 of the case 7 (cf. FIG. 8). Next, water with fertilized eggs is supplied from the water supply aperture 77A. The water is supplied to a portion between the lower surface 12 of the fertilized-egg-holding-plate 1 and the bottom plate portion 71 of the case 7. As a result, the fertilized-egg-holding-plate 1 floats upward till the fertilized-egg-holding-plate 1 touches the rectangular frame lib 79 (cf. FIG. 14). The liquid-absorbing pool 75, in which water with fertilized egg is filled, is formed under the fertilized-egg-holding-plate 1. The fertilized eggs in the liquid-absorbing pool 75 are collected in the concave portions of the fertilized-egg-holding-plate 1. The concave portion holds the fertilized egg stably. The fertilized-egg-holding-plate 1 is descended, when almost concave portions accumulate the fertilized egg each.

The lower surface 12 of the fertilized-egg-holding-plate 1 adheres to the bottom plate portion 71 of the case 7 (cf. FIG. 15) by means of descending the fertilized-egg-holding-plate 1. The bottom plate portion 71 of the case 7 serves as the shutter plate. The fertilized eggs in the concave portions of the fertilized-egg-holding-plate 1 are covered with the bottom plate portion 71. Then, the needle of the injection apparatus is inserted into the through-hole opening on the top surface 11 of the fertilized-egg-holding-plate 1. The gene is injected into the fertilized egg with the needle. Then, weak vibration is given to an outer side surface of the case 7. As a result, the fertilized eggs, which are finished with the injection, fall down under the fertilized-egg-holding-plate 1.

### The Embodiment 7

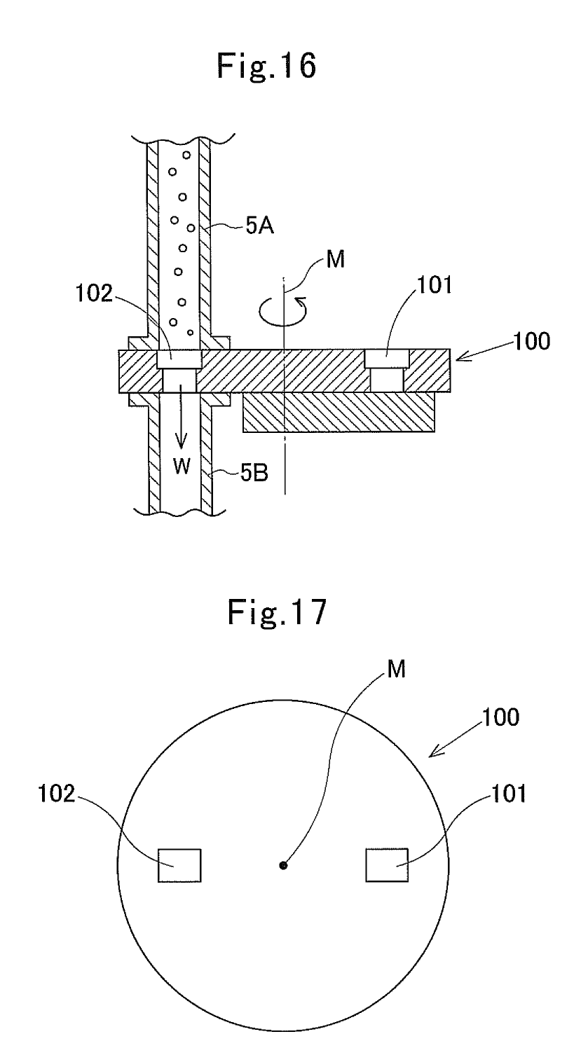

The fertilized egg collection apparatus of the embodiment 7 is explained referring to FIGS. 16-18. FIG. 16 is a vertical cross-section showing a rotary disk 100. Water including the fertilized eggs fall from the water tank 1 shown in FIG. 4through an upper drainage conduit 5A. A lower drainage conduit 5B is arranged just under the upper drainage conduit 5A. The lower drainage conduit 5B drains the drainage dropping from the upper drainage conduit 5A.

The rotary disk 100 is posted in a gap between the upper drainage conduit 5A and the lower drainage conduit 5B. FIG. 17 is a plan view of the rotary disk 100. The rotary disk 100 rotates around a central axis M. The rotary disk 100 has a case-accommodating aperture 101 and a drainage aperture 102. The case 103 mentioned later is accommodated in the case-accommodating aperture 101. The drainage aperture 102 does not have the case 103. The upper end of the case 103 is opened. A bottom portion of the case 103 consists of a net. The net collects fertilized eggs.

The case-accommodating aperture 101 and the drainage aperture 102 are arranged alternately in the gap between the upper drainage conduit 5A and the lower drainage conduit 5B by means of rotating the rotary disk 100. The water falling down from the upper drainage conduit 5A further drops in the lower drainage conduit 5B through the case 103 accommodated in the case-accommodating aperture 101, when the case-accommodating aperture 101 is posted between the upper drainage conduit 5A and the lower drainage conduit 5B. The rotary disk 100 prevents the falling of the water from the upper drainage conduit 5A, when the case-accommodating aperture 101 is not posted between the upper drainage conduit 5A and the lower drainage conduit 5B. The water which fell down from the upper drainage pipe 5A falls to the lower drainage conduit 5B through the drainage aperture 102, when the drainage aperture 102 is posted between the upper drainage conduit 5A and the lower drainage conduit 58.

The case-accommodating-aperture 101 is posted between the upper drainage conduit 5A and the lower drainage conduit 58 at the same time when the lighting apparatus for lighting up the water tank is turned on. The case 103 collects fertilized eggs. The rotary disk 100 rotates, after the collection of the fertilized eggs is finished, and the drainage is interrupted. The drainage aperture 102 is posted between the upper drainage conduit 5A and the lower drainage conduit 5B during a predetermined period just before the collection of fertilized eggs. Water in the water tank is changed, and clean water is filled up in the water tank.

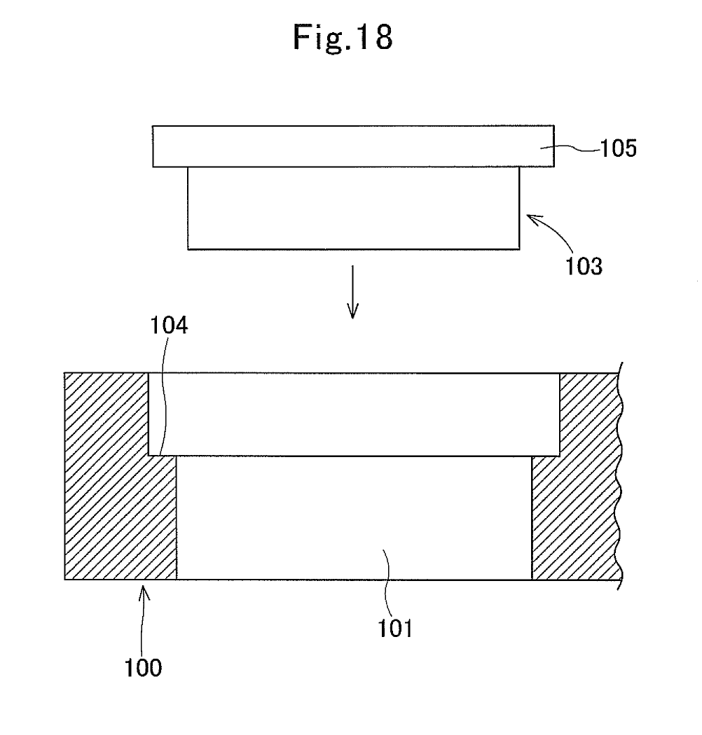

The case 103 and the case-accommodating-aperture 101 of the rotary disk 100 are shown in FIG. 18. A step portion 104 is formed on a side surface of the case-accommodating aperture 101. The case 103 has a brim portion 105. The brim portion 105 is put on the step portion 104, when the case 103 is accommodated in the case-accommodating aperture 101.

### The Embodiment 8

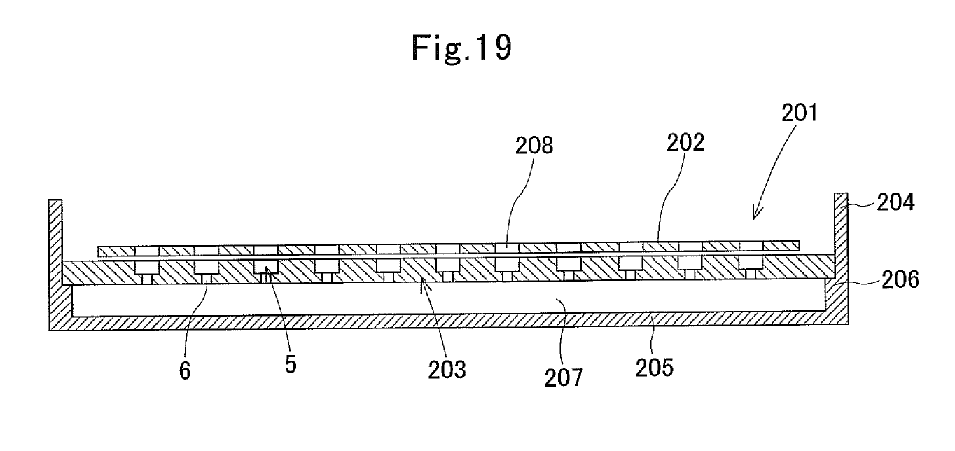

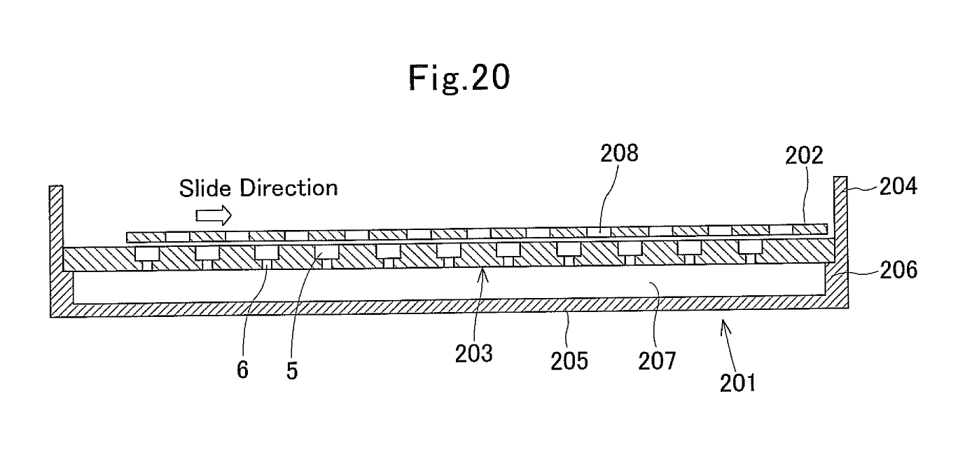

A fertilized egg collection apparatus of the embodiment 8 is explained referring to FIGS. 19-20. FIGS. 19 and 20 are cross-sections of a case 201 having a fertilized-egg-holding-plate inside. FIG. 19 shows a state that a shutter plate 202 is opened. FIG. 20 shows a state that the shutter plate 202 is closed. The case 201 shows arrangement of the case 7 shown in FIG. 7. The case 201 has a different shutter plate 202 from the case shown in FIG. 7. Structure of the case 201 and the fertilized-egg-holding-plate 203 except the shutter plate 202 is essentially same as the case 7 and the fertilized-egg-holding-plate 1, which are shown in FIG. 7. Therefore, the explanation of the case 201 and the fertilized-egg-holding-plate 203 is omitted. The shutter plate 202 of the embodiment is explained below.

A large number of the concave portions 5 are arranged on the top surface of the fertilized-egg-holding-plate 1. The cylinder-shaped concave portion 5 has a shallow bottom. The concave portion 5 has a little bigger diameter (preferably about 2 mm) than the biggest diameter (1.5 mm) of the fertilized egg. The concave portion 5 can accommodate only one fertilized egg of zebra fish. A through-hole 6 is arranged at a central portion of a base 51 of the concave portion 5. The diameter of the through-hole 6 is smaller than the smallest diameter (for example, 0.7 mm) of the fertilized egg.

The case 201 has a sided wall portion 204. The rectangular-frame-shaped sided wall portion 204 is arranged along a penumbra of a bottom plate portion 205. The penumbra of the fertilized-egg-holding-plate 203 is set on a pedestal region 206 disposed at an intermediate portion of the sided wall portion 204 in the height direction. Water in the drainage room (a drainage pool) 207 under the fertilized-egg-holding-plate 203 is drained outside.

The shutter plate 202 is set on the upper surface of the fertilized-egg-holding-plate 203, and the shutter plate 202 can slide along an upper surface of the fertilized-egg-holding-plate 203. The shutter plate 202 has a large number of the fertilized-egg-passing-apertures 208. The fertilized-egg-passing-apertures 208 are established at the same position as the concave portions 5 of the fertilized-egg-holding-plate 203 as shown in FIG. 19. Fertilized-egg-passing-apertures 208 have the same diameter as the concave portion 5. The fertilized egg can pass through the fertilized-egg-passing-aperture 208. A pitch between two fertilized-egg-passing-apertures 208 adjacent to each other has more than double lengths than the fertilized-egg-passing-aperture 208 in a direction of sliding the shutter plate 202,

The shutter plate 202 can cover the concave portions 5 of the fertilized-egg-holding-plate 203, when the shutter plate 202 slides for about one-half of a pitch of the fertilized-egg-passage-apertures 208. According to the embodiment, the compact case 201 can be realized, because the sliding distance of the shutter plate is short. Furthermore, the sided wall of the case 201 prevents that the water on the shutter plate 202 spreads.

(The Operation)

At first, the fertilized-egg-holding-plate 1 is on the bottom plate 71 of the case 7 (cf. FIG. 8). Next, water with fertilized eggs is supplied from the water supply aperture 77A. The water is supplied to a portion between the lower surface 12 of the fertilized-egg-holding-plate 1 and the bottom plate portion 71 of the case 7. As a result, the fertilized-egg-holding-plate 1 floats upward till the fertilized-egg-holding-plate 1 touches the rectangular frame lib 79 (cf. FIG. 14). The liquid-absorbing pool 75, in which water with fertilized egg is filled, is formed under the fertilized-egg-holding-plate 1. The fertilized eggs in the liquid-absorbing pool 75 are collected in the concave portions of the fertilized-egg-holding-plate 1. The concave portion holds the fertilized egg stably. The fertilized-egg-holding-plate 1 is descended, when almost concave portions accumulate the fertilized egg each.

The lower surface 12 of the fertilized-egg-holding-plate 1 adheres to the bottom plate portion 71 of the case 7 (cf. FIG. 15) by means of descending the fertilized-egg-holding-plate 1. The bottom plate portion 71 of the case 7 serves as the shutter plate. The fertilized eggs in the concave portions of the fertilized-egg-holding-plate 1 are covered with the bottom plate portion 71. Then, the needle of the injection apparatus is inserted into the through-hole opening on the top surface 11 of the fertilized-egg-holding-plate 1. The gene is injected into the fertilized egg with the needle. Then, weak vibration is given to an outer side surface of the case 7. As a result, the fertilized eggs, which are finished with the injection, fall down under the fertilized-egg-holding-plate 1.

### The Embodiment 7

The fertilized egg collection apparatus of the embodiment 7 is explained referring to FIGS. 16-18. FIG. 16 is a vertical cross-section showing a rotary disk 100. Water with the fertilized eggs fall down from the water tank 1 shown in FIG. 4 through an upper drainage conduit 5A. A lower drainage conduit 5B is arranged just under the upper drainage conduit 5A. The lower drainage conduit 5B drains the drainage dropping from the upper drainage conduit 5A.

The rotary disk 100 is posted in a gap between the upper drainage conduit 5A and the lower drainage conduit 58. FIG. 17 is a plan view of the rotary disk 100. The rotary disk 100 rotates around a central axis M. The rotary disk 100 has a case-accommodating aperture 101 and a drainage aperture 102. The case 103 mentioned later is accommodated in the case-accommodating aperture 101. The drainage aperture 102 does not have the case 103. The upper end of the case 103 is opened. A bottom portion of the case 103 consists of a net. The net collects fertilized eggs.

The case-accommodating aperture 101 and the drainage aperture 102 are arranged alternately in the gap between the upper drainage conduit 5A and the lower drainage conduit 5B by means of rotating the rotary disk 100. The water falling down from the upper drainage conduit 5A further drops in the lower drainage conduit 5B through the case 103 accommodated in the case-accommodating aperture 101, when the case-accommodating aperture 101 is posted between the upper drainage conduit 5A and the lower drainage conduit 5B. The rotary disk 100 prevents the falling of the water from the upper drainage conduit 5A, when the case-accommodating aperture 101 is not posted between the upper drainage conduit 5A and the lower drainage conduit 5B. The water which fell down from the upper drainage pipe 5A falls to the lower drainage conduit 5B through the drainage aperture 102, when the drainage aperture 102 is posted between the upper drainage conduit 5A and the lower drainage conduit 5B.

The case-accommodating-aperture 101 is posted between the upper drainage conduit 5A and the lower drainage conduit 5B at the same time when the lighting apparatus for lighting up the water tank is turned on. The case 103 collects fertilized eggs. The rotary disk 100 rotates, after the collection of the fertilized eggs is finished, and the drainage is interrupted. The drainage aperture 102 is posted between the upper drainage conduit 5A and the lower drainage conduit 5B during a predetermined period just before the collection of fertilized eggs. Water in the water tank is changed, and clean water is filled up in the water tank.

The case 103 and the case-accommodating-aperture 101 of the rotary disk 100 are shown in FIG. 18. A step portion 104 is formed on a side surface of the case-accommodating aperture 101. The case 103 has a brim portion 105. The brim portion 105 is put on the step portion 104, when the case 103 is accommodated in the case-accommodating aperture 101.

### The Embodiment 8

A fertilized egg collection apparatus of the embodiment 8 is explained referring to FIGS. 19-20. FIGS. 19 and 20 are cross-sections of a case 201 having a fertilized-egg-holding-plate inside. FIG. 19 shows a state that a shutter plate 202 is opened. FIG. 20 shows a state that the shutter plate 202 is closed. The case 201 shows arrangement of the case 7 shown in FIG. 7. The case 201 has a different shutter plate 202 from the case shown in FIG. 7. Structure of the case 201 and the fertilized-egg-holding-plate 203 except the shutter plate 202 is essentially same as the case 7 and the fertilized-egg-holding-plate 1, which are shown in FIG. 7. Therefore, the explanation of the case 201 and the fertilized-egg-holding-plate 203 is omitted. The shutter plate 202 of the embodiment is explained below.

A large number of the concave portions 5 are arranged on the top surface of the fertilized-egg-holding-plate 1. The cylinder-shaped concave portion 5 has a shallow bottom. The concave portion 5 has a little bigger diameter (preferably about 2 mm) than the biggest diameter (1.5 mm) of the fertilized egg. The concave portion 5 can accommodate only one fertilized egg of zebra fish. A through-hole 6 is arranged at a central portion of a base 51 of the concave portion 5. The diameter of the through-hole 6 is smaller than the smallest diameter (for example, 0.7 mm) of the fertilized egg.

The case 201 has a sided wall portion 204. The rectangular-frame-shaped sided wall portion 204 is arranged along a penumbra of a bottom plate portion 205. The penumbra of the fertilized-egg-holding-plate 203 is set on a pedestal region 206 disposed at an intermediate portion of the sided wall portion 204 in the height direction. Water in the drainage room (a drainage pool) 207 under the fertilized-egg-holding-plate 203 is drained outside.

The shutter plate 202 is set on the upper surface of the fertilized-egg-holding-plate 203, and the shutter plate 202 can slide along an upper surface of the fertilized-egg-holding-plate 203. The shutter plate 202 has a large number of the fertilized-egg-passing-apertures 208. The fertilized-egg-passing-apertures 208 are established at the same position as the concave portions 5 of the fertilized-egg-holding-plate 203 as shown in FIG. 19. Fertilized-egg-passing-apertures 208 have the same diameter as the concave portion 5. The fertilized egg can pass through the fertilized-egg-passing-aperture 208. A pitch between two fertilized-egg-passing-apertures 208 adjacent to each other has more than double lengths than the fertilized-egg-passing-aperture 208 in a direction of sliding the shutter plate 202,

The shutter plate 202 can cover the concave portions 5 of the fertilized-egg-holding-plate 203, when the shutter plate 202 slides for about one-half of a pitch of the fertilized-egg-passage-apertures 208. According to the embodiment, the compact case 201 can be realized, because the sliding distance of the shutter plate is short. Furthermore, the sided wall of the case 201 prevents that the water on the shutter plate 202 spreads.

1. A fertilized egg collection apparatus having:
a water tank in which fishes lay eggs;
a fertilized egg separation means for separating fertilized eggs in the water tank from the fishes; and
a fertilized egg collection means for collecting the fertilized eggs from the water tank;
wherein the fertilized egg collection apparatus has an illumination control means for controlling an illumination of the water tank;
the illumination controlling means increases the illumination just before a scheduled egg-laying point in time;
the fertilized egg collection means starts to collect the fertilized eggs with synchronizing to the increasing of the illumination;
the fertilized egg separation means has a draining means and a net for separating the fishes;
the net is disposed at an intermediate portion of the water tank in the height direction of the water tank;
the net has a large number of apertures capable of passing the fertilized eggs and capable of stopping the fishes;
the draining means drains water with the fertilized eggs from a bottom portion of the water tank for at least predetermined period just after the illumination is increased;
the fertilized egg collection means collects the fertilized eggs from the water drained from the water tank;
the draining means drains alien substances in the water tank outside by means draining the water in the water tank, at least just before the illumination of the water tank is increased;
the draining means has an alien-substance-collection-conduit, a fertilized-egg-collection-conduit and a changing means;
the alien-substance-collection-conduit transfers the water drained from the water tank into an alien substance collection means for collecting the alien substances;
the fertilized-egg-collection-conduit diverges from the alien-substance-collection-conduit, and transfers the water in the water tank into the fertilized egg collection means;
the changing means changes the drainage to the alien-substance-collection-conduit and the drainage to the fertilized-egg-collection-conduit; and
the fertilized egg collection means drains the water in the water tank into the fertilized-egg-collection-conduit by means of controlling the changing means for a scheduled period just after the illumination is increased in order to promote the laying of eggs.

2. (canceled)

3. The fertilized egg collection apparatus according to claim 1, wherein the illumination control means increases the illumination of the water tank and the illumination has a step-shaped-waveform in the increasing.

4. The fertilized egg collection apparatus according to claim 3, wherein the illumination control means shields outside lighting for lighting the water tank during a scheduled period before the point in time when the illumination is increased.

5-7. (canceled)

8. The fertilized egg collection apparatus according to claim 1, wherein the draining means has a drainage passage for draining water outside from the water tank;
the fertilized egg collection means has a fertilized-egg-collecting-container having a passage capable of passing the water and capable of stopping the fertilized eggs; and
the fertilized-egg-collecting-container is disposed at an intermediate portion of the drainage passage, and the container can remove the intermediate portion of the drainage passage freely.

9. The fertilized egg collection apparatus according to claim 1, wherein the fertilized egg collection apparatus further has a fertilized-egg-holding-plate and a plate-holding-case;
the fertilized-egg-holding-plate has one major surface having a number of concave portions capable of accommodating only one fertilized-egg in the water;
the box-shaped plate-holding-case has an opened upper end;
the water in the concave portions is drained from the other major surface of the plate-holding-case via a through-hole formed at a bottom plate portion of the fertilized-egg-holding-plate;
the through-hole has a diameter capable of stopping the fertilized egg;
the fertilized egg is caught in the concave portion by means of darning draining water from the concave portion of the fertilized-egg-holding-plate via the drainage aperture;
a sided wall of the plate-holding-case supports a penumbra of the fertilized-egg-holding-plate at a position being apart from the bottom portion of the plate-holding-case; and
the plate-holding-case has the drainage aperture draining water of a drainage room formed between the bottom portion of the plate-holding-case and the fertilized-egg-holding-plate outside.

10. The fertilized egg collection apparatus according to claim 9, wherein the fertilized-egg-holding-plate capable of removing the plate-holding-case is put on the plate-holding-case.

11. The fertilized egg collection apparatus according to claim 10, wherein the sided wall of the plate-holding-case has a pedestal portion on which a penumbra of the fertilized-egg-holding-plate is put.

12. The fertilized-egg-holding-plate according to claim 10, wherein the sided wall of the plate-holding-case has a predetermined height from the fertilized-egg-holding-plate.

13. The fertilized egg collection apparatus according to claim 1, wherein the fertilized egg collection apparatus has a shutter plate adjacent and in parallel to the fertilized-egg-holding-plate with one major surface on which a plurality of concave portions capable of accommodating only one fertilized egg each in the water is arranged;
the water in the concave portions is drained from the other major surface side of the fertilized-egg-holding-plate via a through-hole formed at a bottom portion of the fertilized-egg-holding-plate;
the through-hole has a diameter through which the fertilized egg can not pass;
the fertilized egg is accommodated in the concave portion by means of draining water from the concave portion of the fertilized-egg-holding-plate via the drainage aperture;
the shutter plate closes the concave portion of the fertilized-egg-holding-plate plate by means of shifting the shutter plate in parallel direction to the fertilized-egg-holding-plate, and
the fertilized egg can not pass thorough the concave portion.

14. The fertilized egg collection apparatus according to claim 13, wherein the shutter plate has each fertilized-egg-passing-aperture through which the fertilized egg is capable of passing;
each of the fertilized-egg-passing-apertures is arranged at an equal position to each of the concave portions of the fertilized-egg-holding-plate;
the shutter plate is capable of moving toward a direction in parallel to the fertilized-egg-holding-plate and the shutter plate; and
the shutter plate covers the concave portions by means of moving the shutter plate in order to shifting a relative position between the concave portions and the fertilized-egg-passing-apertures.

15. The fertilized egg collection apparatus according to claim 13, wherein a diameter of the fertilized-egg-passing-aperture is less than a half distance between two fertilized-egg-passing-apertures adjacent to each other in the moving direction of the shutter plate.

16. The fertilized egg collection apparatus according to claim 13, wherein the fertilized-egg-holding-plate and the shutter plate are accommodated in a box-shaped plate-holding-case of which an upper end is opened;
a sided wall portion of said case supports a penumbra of the fertilized-egg-holding-plate at a position apart from a bottom portion of the plate-holding-case; and
the plate-holding-case has a drainage aperture draining water of a drainage room formed between the fertilized-egg-holding-plate and the bottom portion of the plate-holding case outside.

17. The fertilized egg collection apparatus according to claim 16, wherein the sided wall portion of the plate-holding-case has a predetermined height from the fertilized-egg-holding-plate.

18. The fertilized egg collection apparatus according to claim 13, wherein the fertilized egg collection apparatus has an injection means for inserting a needle for injecting genes into the fertilized egg; and
the needle is inserted into the fertilized egg through the fertilized-egg-passing-aperture of the shutter plate.

19. A fertilized egg collection apparatus having a fertilized-egg-holding-plate of which one major surface has a number of concave portions having a size capable of accommodating only one fertilized egg each;
wherein water in the concave portions is drained from the other major surface side of the fertilized-egg-holding-plate via a through-hole formed at a bottom portion of the fertilized-egg-holding-plate;
the through-hole has a diameter through which the fertilized egg can not pass; and
the fertilized egg is accommodated in the concave portion by water stream drained from the concave portion of the fertilized-egg-holding-plate through the drainage aperture;
wherein the fertilized egg collection apparatus has a box-shaped plate-holding-case of which an upper end is opened;
a sided wall of the plate-holding-case supports a penumbra of the fertilized-egg-holding-plate at a position being apart from a bottom portion of said case; and
the plate-holding-case has the drainage aperture draining water of a drainage room formed between the bottom portion of the plate-holding-case and the fertilized-egg-holding-plate outside.

20. The fertilized egg collection apparatus according to claim 19, wherein the fertilized-egg-holding-plate is held by the plate-holding-case, and the fertilized-egg-holding-plate is capable of removing the plate-holding-case.

21. The fertilized egg collection apparatus according to claim 20, wherein the sided wall of the plate-holding-case has a pedestal portion on which the penumbra of the fertilized-egg-holding-plate is put.

22. The fertilized-egg-holding-plate according to claim 20, wherein the sided wall of the plate-holding-case has a predetermined height from the fertilized-egg-holding-plate.

23. A fertilized egg collection apparatus having a fertilized-egg-holding-plate of which one major surface has a number of concave portions having a size capable of accommodating only one fertilized egg each;
wherein water in the concave portions is drained from the other major surface side of the fertilized-egg-holding-plate via a through-hole formed at a bottom portion of the fertilized-egg-holding-plate;
the through-hole has a diameter through which the fertilized egg can not pass; and
the fertilized egg is accommodated in the concave portion by water stream drained from the concave portion of the fertilized-egg-holding-plate through the drainage aperture;
wherein the fertilized egg collection apparatus has a shutter plate adjacent and in parallel to the fertilized-egg-holding-plate;
the shutter plate closes the concave portion of the fertilized-egg-holding-plate by means of shifting the shutter plate in parallel direction to the fertilized-egg-holding-plate; and
the fertilized egg can not pass thorough the concave portion.

24. The fertilized egg collection apparatus according to claim 23, wherein the shutter plate has each fertilized-egg-passing-aperture through which the fertilized egg is capable of passing;
each of the fertilized-egg-passing-apertures is arranged at an equal position to each of the concave portions of the fertilized-egg-holding-plate;
the shutter plate is capable of moving toward a direction in parallel to the fertilized-egg-holding-plate and the shutter plate; and
the shutter plate covers the concave portions by means of moving the shutter plate in order to shifting a relative position between the concave portions and the fertilized-egg-passing-apertures.

25. The fertilized egg collection apparatus according to claim 23, wherein a diameter of the fertilized-egg-passing-aperture is less than a half distance between two fertilized-egg-passing-apertures adjacent to each other in the moving direction of the shutter plate.

26. The fertilized egg collection apparatus according to claim 23, wherein the fertilized-egg-holding-plate and the shutter plate are accommodated in a box-shaped plate-holding-case of which an upper end is opened;
a sided wall portion of said case supports a penumbra of the fertilized-egg-holding-plate at a position apart from a bottom portion of the plate-holding-case; and
the plate-holding-case has a drainage aperture draining water of a drainage room formed between the fertilized-egg-holding-plate and the bottom portion of the plate-holding case outside.

27. The fertilized egg collection apparatus 26, wherein the sided wall portion of the plate-holding-case has a predetermined height from the fertilized-egg-holding-plate.
